(19) United States
(12) Patent Application Publication
(10) Pub. No.: US 2011/0059232 A1
(43) Pub. Date: Mar. 10, 2011

(54) Method for forming transparent organic electrode

(75) Inventors: Jong Young Lee, Suwon (KR); Yongsoo Oh, Seongnam (KR); Young Ki Baek, Suwon (KR); Ho Joon Park, Seoul (KR)

(73) Assignee: SAMSUNG ELECTRO-MECHANICS CO., LTD., Suwon (KR)

(21) Appl. No.: 12/923,145

(22) Filed: Sep. 3, 2010

(30) Foreign Application Priority Data
Sep. 7, 2009 (KR) 10-2009-0084210
Aug. 24, 2010 (KR) 10-2010-0082121

(51) Int. Cl. B05D 5/12

(52) U.S. Cl. 427/77

(57) ABSTRACT

A method for forming a transparent organic electrode includes: preparing an organic conductive composition including a conductive material, a binder, and a solvent; preparing a substrate on which cutting lines demarcating cells are formed; forming a conductive layer by printing a conductive pattern within each of the cells demarcated by the cutting lines by using the organic conductive composition; and dicing the substrate along the cutting lines to separate the cells each having the conductive layer formed thereon. A transparent organic electrode can be formed with good transparency while consuming less raw materials and having a low defectivity rate.

### CROSS-REFERENCE TO RELATED APPLICATIONS

This application claims the priority of Korean Patent Application Nos. 10-2009-0084210 filed on Sep. 7, 2009, and 10-2010-0082121 filed on Aug. 24, 2010, in the Korean Intellectual Property Office, the disclosures of which are incorporated herein by reference.

### BACKGROUND OF THE INVENTION

1. Field of the Invention

The present invention relates to a method for forming a transparent organic electrode and, more particularly, to a method for forming a transparent organic electrode with good transparency while consuming less raw materials and having a low rate of defectivity.

2. Description of the Related Art

As computers, various home appliances, and communications devices are being digitalized and rapidly advancing to have increasingly high performance, the implementation of large-scale portable displays is urgently required. In order to implement a large-scale flexible portable display, a display material that can be bent or folded, in the manner of a newspaper, is required.

To this end, an electrode material for a display needs to be transparent, have a low resistance value, have a high strength for mechanical stability in the case that an element is bent or folded, have a similar coefficient of thermal expansion to that of a plastic substrate so that even when the device is overheated or has a high temperature, it can escape from a short-circuited state or a great change in surface resistance.

Because a flexible display makes it possible to manufacture a display of a certain shape, it can be used for a clothing trademark, a billboard, a showcase price sign, a large scale electricity lighting system, and the like, which may have changing colors or patterns, as well as a portable display device, and in this sense, the utilization of the flexible display is forecast to be extremely high.

Currently, research into forming a conductive layer by coating a substrate with various metal oxides such as indium, tin, zinc, titanium, cesium, and the like, by using a chemical deposition method, a magnetron sputtering method, and a reactive evaporation method is actively ongoing in order to manufacture a transparent conductive material, both domestically and abroad. However, the process of coating the metal oxides on the substrate requires a vacuum, incurring high processing costs.

Here, a transparent conductive material formed by coating a metal oxide on a large-scale substrate is cut into unit cells as required by users and is then provided to the users. However, the rate of crack generation on the sections of the transparent electrodes, namely, in the edges of the unit cells, due to mechanical stress applied thereto during the cutting process is so high that the manufacturing yield of the transparent electrode is very low.

In addition, attaching the electrode to the transparent conductive material having the metal oxide conductive layer necessarily accompanies a process of removing the conductive layer from a portion on which an electrode is to be attached, increasing the manufacturing cost thereof.

### SUMMARY OF THE INVENTION

An aspect of the present invention provides a method for forming a transparent organic electrode with good transparency while less consuming less raw materials and having a low rate of defectivity.

According to an aspect of the present invention, there is provided a method for forming a transparent organic electrode, including: preparing an organic conductive composition including a conductive material, a binder, and a solvent; preparing a substrate on which cutting lines demarcating cells are formed; forming a conductive layer by printing a conductive pattern within each of the cells demarcated by the cutting lines by using the organic conductive composition; and dicing the substrate along the cutting lines to separate the cells, each having the conductive layer formed thereon.

In forming the conductive layer, one conductive pattern may be printed within each of the cells.

In forming the conductive layer, two or more conductive patterns may be printed within each of the cells.

The conductive patterns may have a circular or polygonal shape.

The organic conductive composition may include a viscosity modulator.

The conductive material may include one or more of a conductive polymer, a metal nano material, a carbon nano tube, and a conductive ink.

The conductive polymer may be poly-3,4-ethyleneoxythiopene/polystyrenesulfonate (PEDOT/PSS), or polyaniline.

The conductive material may be 3 weight parts to 50 weight parts over 100 weight parts of the entire composition, and the binder may be 1 weight part to 40 weight parts over 100 weight parts of the entire composition.

The method may further include: thermally treating the conductive layer after the operation of forming the conductive layer.

The thermal treating of the conductive layer may be performed at room temperature or 400° C.

The thermal treating of the conductive layer may be preferably performed at 25° C. to 150° C.

The conductive pattern may be formed through inkjet printing, screen printing, Gravure printing, or offset printing.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1a to 1c is illustrate the sequential process of forming a transparent organic electrode according to an exemplary embodiment of the present invention;

FIGS. 2a and 2b are perspective views of cells according to another exemplary embodiment of the present invention;

FIG. 3a is a graph showing variations of resistance values of cells over temperature of a thermal treatment; and

FIG. 3b is a graph showing crack generation rates over temperature of a thermal treatment.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

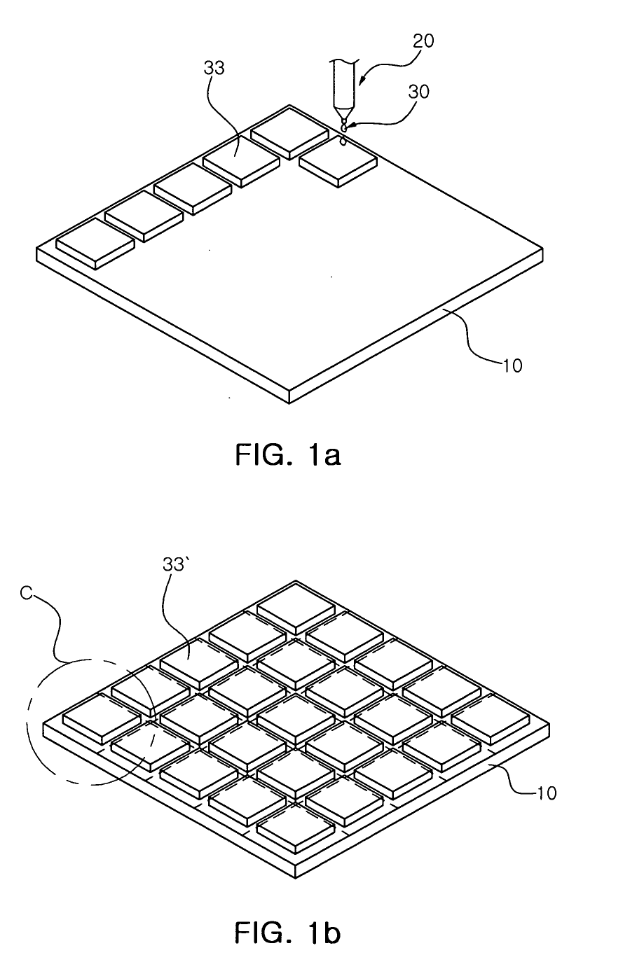

The process for forming a transparent organic electrode according to an exemplary embodiment of the present invention will now be described with reference to FIGS. 1a to 1c.

FIG. 1a is a perspective view showing a sequential process of forming conductive patterns separated at certain intervals on a substrate by using an organic conductive composition according to an exemplary embodiment of the present invention. FIG. 1b is a schematic perspective view showing conductive patterns formed on the substrate according to an exemplary embodiment of the present invention. FIG. 1c is a schematic perspective view showing the process of cutting the substrate with thermally treated conductive patterns formed thereon by cells according to an exemplary embodiment of the present invention.

According to an exemplary embodiment of the present invention, cells on which a conductive pattern is printed in the form of a pattern to form a conductive layer, respectively, are manufactured. The cell refers to minimum unit of an electrical element that can perform an electrical function.

A substrate can be cut by cells to manufacture a plurality of cells. To this end, cutting lines are formed to demarcate the cells on the substrate, and the substrate is cut by cells along the cutting lines to thus manufacture the plurality of cells.

One conductive pattern may be printed to form a conductive layer on each of the cells demarcated by the cutting lines on the substrate, or two or more conductive patterns may be printed to form a conductive layer in each cell. The conductive pattern may be printed as a single pattern employed for a resistive type touch screen, or may be printed as a circular or polygonal pattern such as a bar-like pattern, triangular pattern, or diamond-like pattern employed for a capacitive type touch screen.

Before performing the cutting process of cutting the substrate by cells, a conductive electrode (hereinafter, referred to as a ‘conductive pattern’, which is connected to an FPC), whose section is electrically connected to the conductive pattern, may be printed on each cell. After performing the printing, the conductive pattern-formed substrate may be cut along the cutting lines into cells.

The conductive pattern may be made of a material such as Ag paste having good conductivity.

First, the substrate 10 is demarcated by cutting lines CL in the units of cells. The cutting lines CL may be marked on the substrate and may be imaged through an imaging procedure of the substrate 10. After the conductive layer is formed, the cutting lines CL may be diced to form a plurality of cells.

A plurality of conductive patterns 33 separated at certain intervals on the substrate 10 are formed within each of the cells demarcated by the cutting lines by using an organic conductive composition 30. The organic conductive composition 30 is printed in the form of patterns on the substrate 10 to form the conductive patterns 33. The conductive patterns 33 are separated at certain predetermined intervals and printed.

When the substrate is cut by cells along the cutting lines CL such that one or more conductive patterns are included in one cell, the conductive layer constituting each of the cells includes one or more conductive patterns 33.

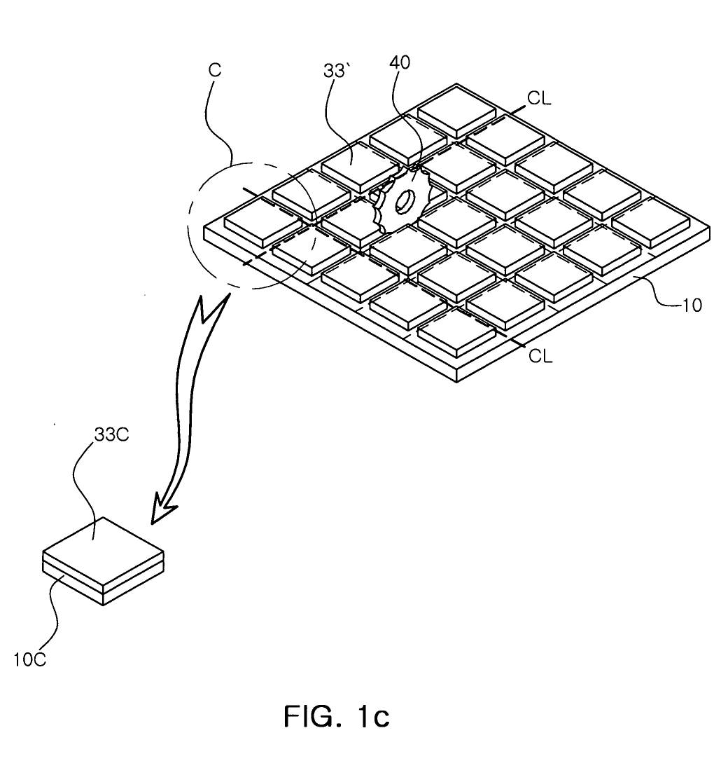

Preferably, one conductive pattern may be formed in one cell (See FIG. 1c), or two or more conductive patterns 33d and 33e may be formed in one cell (See FIG. 2).

In this manner, the cells having the conductive pattern formed thereon may be formed, and accordingly, the conductive layer, on which the organic conductive composition is printed in the form of a pattern, is formed in each of the plurality of cells.

The material of the substrate is not particularly limited, and the substrate 10 may be made of any material so long as it may be easily used to form the conductive pattern on one surface of the substrate. The substrate may be made of a resin, glass, or the like.

The substrate may be made of a colored or colorless material according to its intended purpose. Preferably, when the substrate 10 is provided as a display plane of a display device, the substrate 10 may be made of a transparent material. For example, a resin such as polyethylene terephthalate (PET), polycarbonate (PC), polymethyl methacrylate (PMMA), polyethylene naphthalate (PEN), polyether sulfone (PES), cyclic olefin polymer (COC), and the like, glass, tempered glass, and the like, may be used as a material of the substrate 10.

In the present disclosure, transparency may include colorless transparency, colored transparency, translucency, colored translucency, and the like.

Here, the organic conductive composition 30 may include a conductive material, a binder, a solvent, and the like.

The conductive material may include one or more of a conductive polymer, a metal nano material, a carbon nano tube (or carbon black), and a conductive ink.

The conductive polymer is not particularly limited, and, for example, one of poly-3,4-ethylenedioxythiophene/polystyrenesulfonate (PEDOT/PSS) or polyaniline or a mixture thereof may be used.

The content of the conductive polymer may be 3 weight parts to 50 weight parts over the 100 weight parts of the entire composition. If the content is less than 3 weight parts, electrical conductivity would possibly be degraded, and if the content exceeds 50 weight parts, solubility or transparency would possibly be degraded.

The binder included in the organic conductive composition 30 serves to improve the adhesive power of the organic conductive composition. The binder may include one of a water-soluble low molecular binder, a water-soluble high molecular binder, or a combination thereof. Examples of the binder may include one of alkyl glycidyl ether (metha)acrylate, phenyl glydicyl ether (metha)acrylate, (metha)acrylate and polyfunctional (metha)acrylate, and a combination thereof.

The content of the binder may be 1 weight part to 40 weight parts over the 100 weight parts of the entire composition. If the content is less than 1 weight part, an adhesive force with the substrate would possibly be degraded, and if the content exceeds 40 weight parts, the electrical conductivity thereof would possibly be degraded.

A solvent included in the organic conductive composition is not particularly limited, and one of poly-alcohol, dimethyl sulfoxide (DMSO), N,N-diemthylformamide, ethylene glycol (EG), meso-erythritol, water, and the like, may be used as the solvent.

The content of the solvent may be 2 weight parts to 40 weight parts over the 100 weight parts of the entire composition. If the content is less than 2 weight parts, it would possibly be difficult to uniformly mix the compositions, and if the content exceeds 40 weight parts, electrical conductivity would possibly be degraded.

A viscosity modulator included in the organic conductive composition 30 is not particularly limited, and a viscosity modulator having an organic component may be used.

In the present exemplary embodiment, because the organic conductive composition 30 includes the viscosity modulator, the viscosity of the organic conductive composition 30 can be adjusted according to a printing method applied to form the conductive patterns 33. The viscosity of the organic conductive composition 30 may be adjusted to be, preferably, 400 mPas or lower, or more preferably, 60 mPas to 200 mPas, but the present invention is not limited thereto.

The viscosity of the organic conductive composition 30 may be properly adjusted according to a printing method. If the viscosity thereof is too strong or too weak, the organic conductive composition cannot be applied to be printed, making it difficult to form conductive patterns on the substrate. Thus, the viscosity modulator of the organic conductive composition 30 needs to be adjusted to have a suitable viscosity.

In order to manufacture an organic conductive composition with proper viscosity, the content of the viscosity modulator may be 0 weight parts to 40 weight parts over 100 weight parts of the entire composition.

If the content of the viscosity modulator is less than 0 weight parts, it would be difficult to adjust the organic conductive composition with desired viscosity, and if the content exceeds 40 weight parts, the electrical conductivity would possibly be degraded.

The method for forming the conductive patterns 33 using the organic conductive composition 30 is not particularly limited. For example, the method for forming the conductive patterns 33 may include inkjet printing, screen printing, Gravure printing, or offset printing. In detail, the viscosity of the organic conductive composition 30 may be appropriately adjusted according to the printing method employed.

When the organic conductive composition 30 is thermally treated, it may be thermally treated at room temperature or at 400° C., preferably, at 25° C. to 150° C., but the present invention is not limited thereto. If the temperature of the thermal treatment is lower, the viscosity of the composition would possibly be degraded, and when the temperature of the thermal treatment is higher, the organic conductive composition 30 would possibly be deformed.

The organic conductive composition 30 with appropriately adjusted viscosity provided in a nozzle 20 may be dropped through a printing method to form a plurality of conductive patterns 33 separated at certain intervals on the substrate 10.

The substrate 10 is cut by cells along the cutting lines CL. In this case, the substrate 10 may be cut such that one cell has one or more conductive patterns 33.

The cutting lines CL may be formed according to the desired size and shape of the cells, and later, the cutting lines CL form edges of the cells.

According to an exemplary embodiment of the present invention, the substrate 10 may be cut such that one conductive pattern 33c is formed in one cell as a single pattern, as shown in FIG. 1c. According to another exemplary embodiment of the present invention, the substrate 10 may be cut such that four circular conductive patterns 33d are formed in one cell as shown in FIG. 2a. According to still another exemplary embodiment of the present invention, the substrate 10 may be cut such that four square conductive patterns 33e are formed in one cell as shown in FIG. 2b.

Subsequently, the conductive patterns 33 formed on the substrate 10 are thermally treated to improve an adhesive force between the thermally treated conductive patterns 33′ and the substrate 10.

In addition, in order to improve the adhesive force of the conductive pattern(s), UV may be irradiated onto the substrate 10 or the substrate 10 may be corona-treated or primer-treated.

Thereafter, the conductive patterns 33′, which have been formed on the large substrate 10 and thermally treated, are diced along the cutting lines CL formed on the substrate by using a blade 400 or the like to manufacture a plurality of cells (C), namely, transparent organic electrodes, each with the conductive pattern 33C formed on the unit substrate 10C.

In case of the related art conductive pattern using ITO or the like, patterns are deposited on an entire substrate, which are then exposed, developed, and then cut into unit cells, causing a large amount of raw materials to be consumed and complicating the process.

In addition, in the case of the conductive patterns using ITO or the like, there is a high possibility that the conductive patterns will be cracked in the course of the dicing process due to the material characteristics of the inorganic material.

In comparison, in the present exemplary embodiment, because the organic conductive composition 30 is printed in the form of conductive patterns constituting unit cells on the substrate 10, an exact amount of the organic conductive composition 30 required for forming the unit cells can be used, thus reducing wastage of raw materials.

Also, in the related art dicing process, because the conductive patterns are directly cut, the edges of the conductive patterns are easily cracked to a large extent, but in the present exemplary embodiment, because patterns are printed such that one or more conductive patterns are formed at the inner side of the cutting lines CL constituting the edges of the respective cells and cutting is made along the cutting lines CL by cells, a situation in which the conductive patterns are directly cut does not occur.

Namely, because the cutting lines CL formed on the substrate 10 are cut, the generation of cracks as the patterns are cut can be prevented.

That is, because the organic conductive composition 30 is not printed on the entire substrate 10, wastage of the raw materials can be reduced, and because the conductive patterns are not directly cut, a crack generation rate can be reduced to thus improve the manufacturing yield of the transparent electrodes.

In addition, because the thermally treated conductive patterns 33′ themselves can serve as electrodes, a process of removing a conductive layer from a portion of the transparent conductive material, on which an electrode is to be attached, as in the related art, is unnecessary. Thus, the electrode manufacturing process can be simplified and the manufacturing costs thereof can be reduced.

### Embodiment 1

In order to check for variations in resistance according to the temperature for thermally treating the organic conductive composition, the organic conductive composition was printed for 30 minutes by using inkjet printing, screen printing, Gravure printing, or offset printing, and then the resistance values according to the respective temperatures of thermal treatments were compared.

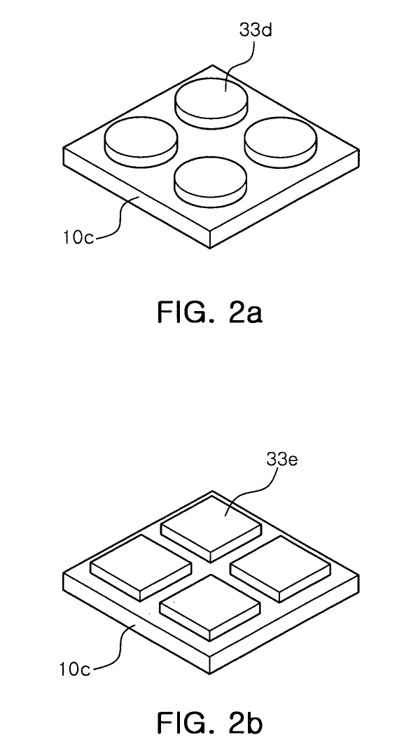

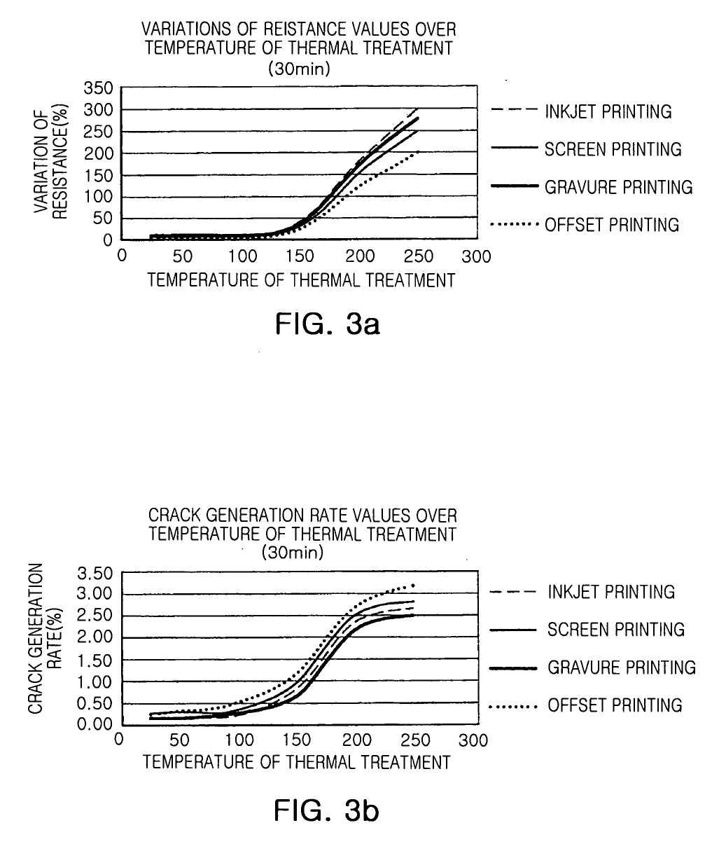

FIG. 3a is a graph of variations of resistance values over temperature of thermal treatment based on various printing methods.

It is noted that when the organic conductive composition was printed through various printing methods and then thermally heated within the temperature range from 25° C. to 150° C., the resistance of unit cells including the organic conductive composition was not greatly increased, while the resistance was sharply increased as the temperature went beyond 150° C.

Namely, it is noted that, according to an exemplary embodiment of the present invention, when the organic conductive composition is thermally treated within the temperature range from 25° C. to 150° C., unit cells having uniform resistance can be manufactured, but if the temperature of the thermal treatment exceeds 150° C., the organic material is deformed to change the characteristics of the organic conductive composition, thereby significantly increasing the resistance thereof.

### Embodiment 2

In order to check crack generation rates according to the temperatures of thermal treatment of the organic conductive composition, the organic conductive composition was printed by using inkjet printing, screen printing, Gravure printing, or offset printing, and then the crack generation rates according to the respective temperatures of thermal treatments were compared.

In the case that the crack generation rate (A) is based on the ratio of the length of a crack per unit length when the crack is generated in a unit area, the more cracks that are generated, the larger the crack generation rate value.

Crack generation rate=length of crack/unit length.

With reference to FIG. 3b, When the cutting lines were formed to demarcate the cells according to an exemplary embodiment of the present invention and conductive patterns within the cells demarcated by the cutting lines were thermally treated, a crack generation rate did not exceed 0.5 although any printing method was employed, and in particular, when the conductive patterns were thermally treated at a temperature below 50° C., a crack generation rate did not exceed 0.3.

Especially, when the conductive patterns were printed by using Gravure printing or inkjet printing and thermally treated at a temperature below 50° C., a crack generation rate did not exceed 0.2.

Namely, no matter which printing methods are employed, when the thermal treatment is performed at a temperature ranging from 25° C. to 150° C., a crack generation rate having a value less than 1 is obtained. However, when the temperature of the thermal treatment exceeds 150° C., the crack generation rate exceeds 1, increasing the defectivity rate of the unit cells.

According to an exemplary embodiment of the present invention, because the organic conductive composition is used, if the organic conductive composition is thermally treated at a high temperature, the organic material is deformed, increasing the crack generation rate of the electrodes. However, when unit cells are manufactured by thermally treating the organic conductive composition within a temperature range in which the organic material is not thermally deformed, the crack generation rate is less than 1, and in particular, when the organic conductive composition is thermally treated at a temperature lower than 100° C., a crack generation rate less than 0.5 is obtained regardless of printing method, so the defectivity rate of electrodes can be considerably reduced.

As set forth above, according to exemplary embodiments of the invention, a transparent organic electrode can be formed with good transparency while consuming less raw materials and a low defectivity rate can be provided.

In addition, because an organic conductive composition printed on a substrate is thermally treated and diced, eliminating the necessity of separately forming a transparent electrode, the process of manufacturing an organic electrode can be simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for forming a transparent organic electrode, the method comprising:
preparing an organic conductive composition including a conductive material, a binder, and a solvent;
preparing a substrate on which cutting lines demarcating cells are formed;
forming a conductive layer by printing a conductive pattern within each of the cells demarcated by the cutting lines by using the organic conductive composition; and
dicing the substrate along the cutting lines to separate the cells, each having the conductive layer formed thereon.

2. The method of claim 1, wherein, in forming the conductive layer, one conductive pattern is printed within each of the cells.

3. The method of claim 1, wherein, in forming the conductive layer, two or more conductive patterns are printed within each of the cells.

4. The method of claim 1, wherein the conductive pattern have a circular or polygonal shape.

5. The method of claim 1, wherein the organic conductive composition comprises a viscosity modulator.

6. The method of claim 1, wherein the conductive material comprises one or more of a conductive polymer, a metal nano material, a carbon nano tube, and a conductive ink.

7. The method of claim 6, wherein the conductive polymer is poly-3,4-ethyleneoxythiopene/polystyrenesulfonate (PEDOT/PSS), or polyaniline.

8. The method of claim 1, wherein the conductive material is 3 weight parts to 50 weight parts over 100 weight parts of the entire composition.

9. The method of claim 1, wherein the binder is 1 weight part to 40 weight parts over 100 weight parts of the entire composition.

10. The method of claim 1, further comprising:
thermally treating the conductive layer, after the operation of forming the conductive layer.

11. The method of claim 10, wherein the thermal treating of the conductive layer is performed at room temperature or 400° C.

12. The method of claim 10, wherein the thermal treating of the conductive layer is performed at 25° C. to 150° C.

13. The method of claim 1, wherein the conductive pattern is formed through inkjet printing, screen printing, Gravure printing, or offset printing.
